(19) United States
(12) Patent Application Publication
(10) Pub. No.: US 2021/0334805 A1
(43) Pub. Date: Oct. 28, 2021

(54) SYSTEM AND METHOD FOR DETECTING EVENTS

(71) Applicant: Capital One Services, LLC, McLean, VA (US)

(72) Inventor: Gregory GOLDSTEIN, Arlington, VA (US)

(73) Assignee: Capital One Services, LLC, McLean, VA (US)

(21) Appl. No.: 16/859,778

(22) Filed: Apr. 27, 2020

(51) Int. Cl. G06Q 20/40; G06Q 40/02; G06K 9/62; G06F 17/16; G06N 5/02

(52) U.S. Cl. CPC G06Q 20/405; G06Q 40/02; G06N 5/025; G06F 17/16; G06K 9/6215

(57) ABSTRACT

A system for detecting a recurring transaction in a history of financial transactions is disclosed. The system receives financial transaction data between a user and a merchant, and organizes the data into a matrix for analysis. The rows of the matrix are time periods, each having a plurality of time units, and the transactions are located in the matrix on the dates on which they occurred. Multiple subroutines are then performed on the transaction matrix. The subroutines include determining nearest transactions to a given column, calculating a distance from the nearest transactions to the column, and comparing the values of the nearest transactions, among others. Based on the results of the various subroutines, a score is calculated that defines a relative likelihood that the given column of the matrix includes a recurring transaction.

### BACKGROUND

The disclosure relates to a system and method for analyzing a history of events in order to detect a recurring event, and more specifically to detecting a recurring transaction from a history of financial transactions.

With the advancement of computer processing and big data capabilities, a wide variety of events, occurrences, transactions, and other actions associated with consumer daily life are stored, cataloged, or otherwise tracked. Often, within this data are patterns, such as recurring behaviors. However, these patterns are generally hidden within the data, separated and obfuscated by numerous unrelated events. The ability to identify these event recurrences and behavioral patterns can be used to provide individuals with quality of life improvements, such as automatic reminders, orders, instructions, etc.

In some previous implementations, detecting recurring transactions has been limited to detecting a distance between adjacent transactions on a timeline. In other words, previous implementations merely measure the time periods between consecutive transactions, and if the periods are substantially similar to each other, then a recurring transaction is identified.

### BRIEF DESCRIPTION OF THE DRAWINGS/FIGURES

Embodiments are described with reference to the accompanying drawings. In the drawings, like reference numbers indicate identical or functionally similar elements. Additionally, the left most digit(s) of a reference number identifies the drawing in which the reference number first appears.

FIG. 1 illustrates an exemplary transaction timeline;

FIG. 2A illustrates a block diagram of an exemplary transaction analysis system;

FIG. 2B illustrates a block diagram of an exemplary recurrence analyzer used by a transaction analysis engine of the transaction analysis system;

FIG. 3A illustrates an exemplary transaction matrix used by the recurrence analyzer;

FIG. 3B illustrates an exemplary transaction matrix used by the recurrence analyzer;

FIG. 4A illustrates a portion of an exemplary transaction matrix centered at a selected column of the transaction matrix;

FIG. 4B illustrates a portion of an exemplary transaction matrix centered at a selected column of the transaction matrix;

FIG. 5A illustrates an exemplary transaction timeline associated with a particular transaction time period;

FIG. 5B illustrates an exemplary transaction timeline associated with the particular transaction time period;

FIG. 6 illustrates a block diagram of an exemplary method for detecting a recurring transaction;

FIG. 7 illustrates a block diagram of an exemplary method for carrying out an alignment subroutine;

FIG. 8 illustrates a block diagram of an exemplary method for carrying out a value comparison subroutine;

FIG. 9 illustrates a block diagram of an exemplary method for carrying out a noise detection subroutine; and

FIG. 10 illustrates a block diagram of an exemplary general purpose computer system.

### DETAILED DESCRIPTION

The following Detailed Description refers to accompanying drawings to illustrate exemplary embodiments consistent with the disclosure. References in the Detailed Description to “one exemplary embodiment,” “an exemplary embodiment,” “an example exemplary embodiment,” etc., indicate that the exemplary embodiment described may include a particular feature, structure, or characteristic, but every exemplary embodiment may not necessarily include the particular feature, structure, or characteristic. Moreover, such phrases are not necessarily referring to the same exemplary embodiment. Further, when a particular feature, structure, or characteristic is described in connection with an exemplary embodiment, it is within the knowledge of those skilled in the relevant art(s) to affect such feature, structure, or characteristic in connection with other exemplary embodiments whether or not explicitly described.

The exemplary embodiments described herein are provided for illustrative purposes, and are not limiting. Other exemplary embodiments are possible, and modifications may be made to the exemplary embodiments within the spirit and scope of the disclosure. Therefore, the Detailed Description is not meant to limit the invention. Rather, the scope of the invention is defined only in accordance with the following claims and their equivalents.

Embodiments may be implemented in hardware (e.g., circuits), firmware, software, or any combination thereof. Embodiments may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact results from computing devices, processors, controllers, or other devices executing the firmware, software, routines, instructions, etc. Further, any of the implementation variations may be carried out by a general purpose computer, as described below.

For purposes of this discussion, the term “module” shall be understood to include at least one of software, firmware, and hardware (such as one or more circuit, microchip, or device, or any combination thereof), and any combination thereof. In addition, it will be understood that each module may include one, or more than one, component within an actual device, and each component that forms a part of the described module may function either cooperatively or independently of any other component forming a part of the module. Conversely, multiple modules described herein may represent a single component within an actual device. Further, components within a module may be in a single device or distributed among multiple devices in a wired or wireless manner.

The following Detailed Description of the exemplary embodiments will so fully reveal the general nature of the invention that others can, by applying knowledge of those skilled in relevant art(s), readily modify and/or adapt for various applications such exemplary embodiments, without undue experimentation, without departing from the spirit and scope of the disclosure. Therefore, such adaptations and modifications are intended to be within the meaning and plurality of equivalents of the exemplary embodiments based upon the teaching and guidance presented herein. It is to be understood that the phraseology or terminology herein is for the purpose of description and not of limitation, such that the terminology or phraseology of the present specification is to be interpreted by those skilled in relevant art(s) in light of the teachings herein.

Those skilled in the relevant art(s) will recognize that this description may be applicable to a wide variety of event without departing from the spirit and scope of the present disclosure. Therefore, although the subsequent discussion is presented with respect to analyzing banking and/or financial transactions, it should be understood that the methods and systems described herein may be equally useful in analyzing and detecting other types of events.

An Exemplary Recurring Transaction Detection System

A wide variety of consumer behavior is conducted through computer systems, including calendars, email, social media, financial transactions, shopping, etc. Many instances of this behavior are logged by the host service providers, which include information relating to the date/time of the event, the event type, etc. With the system and method described herein, recurrences of events and behaviors can be extracted from these logs.

Although this disclosure can be applied to any set of events or event logs, the discussion below is provided in the example context of banking or other financial transactions. For example, banks and other financial institutions have begun to provide their customers with a wide range of quality of life improvements to user experience and ease of use. One such improvement is the automatic detection of certain banking habits and/or patterns. Information such as this is often useful to the user, whether to inform the user of spending habits or for automatically initiating response actions.

For example, a bank may wish to automatically identify recurring transactions of a particular customer. By identifying a recurring transaction, the bank may notify the customer, track recurring transactions for automated balance alerts, or offer automated debiting for transaction simplicity. When such transactions occur, the transactions are logged. These logs typically indicate the date/time of the transaction, a transaction amount, merchant identification, etc. In order to perform the recurrence detection of this disclosure, logged transaction information is aggregated for each user for all transactions with all merchants.

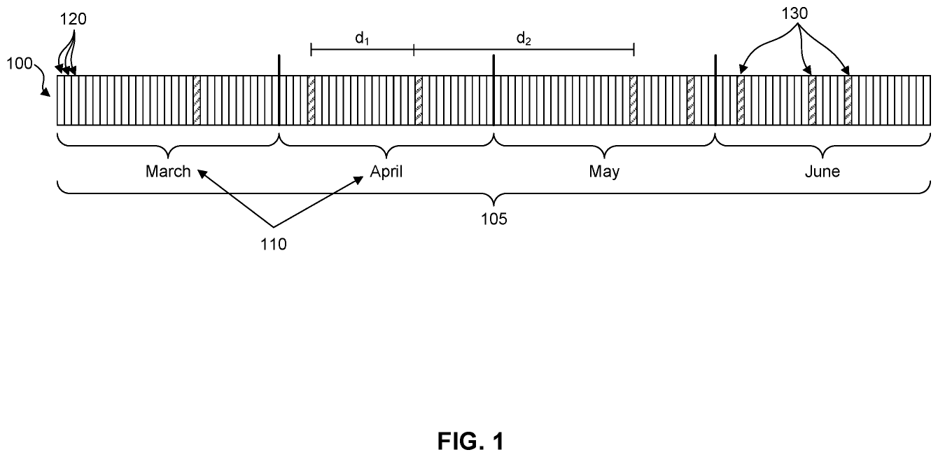

In order to identify recurring transactions, embodiments of the present disclosure extract from the aggregated transactions only those transactions relating to a single merchant. This single-merchant transaction information can be visualized in a timeline, as shown for example in FIG. 1.

FIG. 1 illustrates an exemplary transaction timeline 100 according to an embodiment of the disclosure. The transaction timeline 100 depicts transactions between a single user and a single merchant over a given time duration 105. The time duration 105 is partitioned into a plurality of time periods 110. In the illustrated example, the time duration 105 includes four time periods 110, each one month in length (e.g., March-June).

Each time period includes a plurality of time units 120. In the example transaction timeline 100, each time unit 120 is equal to one day. As shown in FIG. 1, the transaction timeline 100 includes a plurality of transactions 130 that occurred between the user and the merchant. Each transaction 130 occupies a single time unit 120 within the timeline 100, and either includes or points to the transaction data.

In some previous recurrence detection implementations, systems would merely analyze the distance (e.g., time duration) between consecutive transactions. For example, as shown in FIG. 1, another system might analyze the distance d₁ between two consecutive transactions and the distance d₂ between another two consecutive transactions. If the distances d₁ and d₂ are the same or sufficiently similar, then the system identifies the transactions as recurring. In the example of FIG. 1, the distances d₁ and d₂ do not meet this requirement, and would not be identified as recurring transactions. However, this method of identifying recurring transactions is prone to error. For example, in the example of FIG. 1, even though the distances d₁ and d₂ are insufficiently similar to be classified as recurring, the transactions that define the distance d₂ are in fact recurring transactions with other non-consecutive transactions. The conventional detection scheme is not capable of identifying the recurrence of those transactions because of interfering transactions.

The present disclosure improves upon the conventional method. As will be explained in further detail throughout this disclosure, this is achieved through the use of a matrix construction of the transaction timeline 100. Within this construct, the system then performs multiple subroutines. The results of these subroutines are then provided to a scoring engine, which aggregates the results of the various subroutines in order to determine an overall likelihood (e.g., a score) that a recurring transaction is present in the data. A final recurrence determination is made based on a comparison of the score to a threshold value.

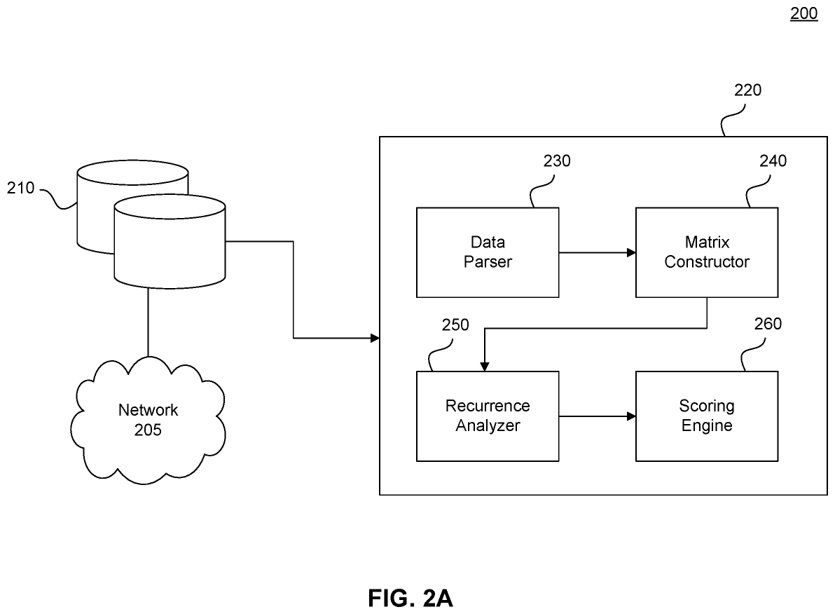

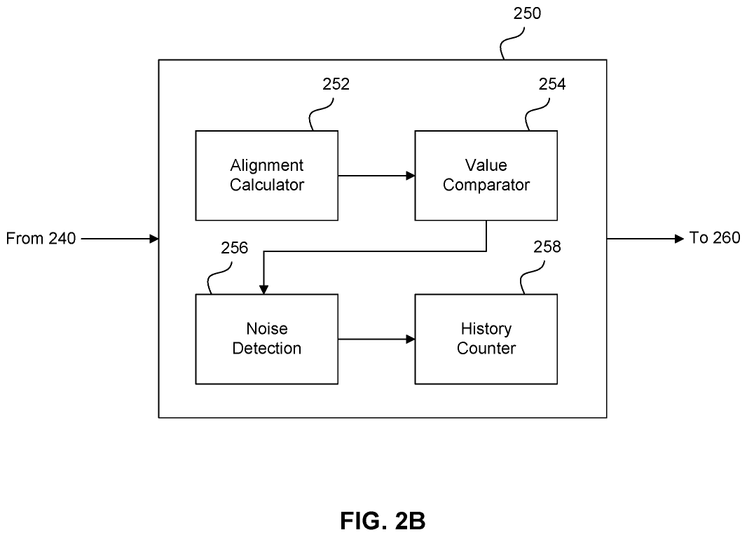

FIG. 2A illustrates a block diagram of an exemplary transaction analysis system 200 according to an embodiment of the present disclosure. The transaction analysis system 200 includes a transaction analysis engine 220 connected to one or more databases 210. In embodiments, the databases 210 can be integrated into the transaction analysis engine 220 or can be provided separately, as either standalone databases or as integrated into other financial institution systems. Additionally, the transaction analysis engine 220 can be connected to the databases 210 either directly or indirectly, such as via a network.

The databases 210 store financial transaction data of the financial transactions that involve the financial institution. As discussed above, each transaction data may include a wide variety of information, such as customer name, merchant name, transaction date, transaction amount, etc. The databases 210 receive the financial transaction data from a variety of different sources via a network 205. In embodiments, the network 205 may include one or more of a Local Area Network (LAN), Wide Area Network (WAN), public-switched telephone network (PSTN), or the Internet, and may consist of packet-switched or circuit-switched routing elements.

The transaction analysis engine 220 includes one or more circuits and/or hardware or software processors configured to carry out the various subroutines of the engine 220. For purposes of discussion, each of the subroutines is described as a separate entity from the others. However, as will be apparent to those of ordinary skill in the art, the subroutines can be carried out by separate, the same, or overlapping hardware or software elements, and may be processed separately, consecutively, or simultaneously. In an embodiment, multiple processing cores are used to process the various subroutines in multiple processing threads so as to increase processing efficiency and reduce processing time.

In an embodiment, the transaction analysis engine 220 includes a data parser 230, a matrix constructor 240, a recurrence analyzer 250, and a scoring engine 260. The data parser 230 parses data from the financial transaction data that is specific to a particular customer/merchant combination. In embodiments, the data parser 230 receives aggregated data from the databases 210, extracts the data specific to the customer/merchant combination of interest, and then generates a transaction timeline from the extracted data. In another embodiment, the data parser 230 requests the relevant data associated with the customer/merchant combination from the databases 210. The received transaction data is then formatted into the transaction timeline, such as the transaction timeline 100 depicted in FIG. 1. In embodiments, the relevant data is identified based on the data fields in the transaction data, such as transactions that include the desired merchant in the “merchant name” field and the desired customer in the “customer name” field. Other data entries, such as date, may also be used.

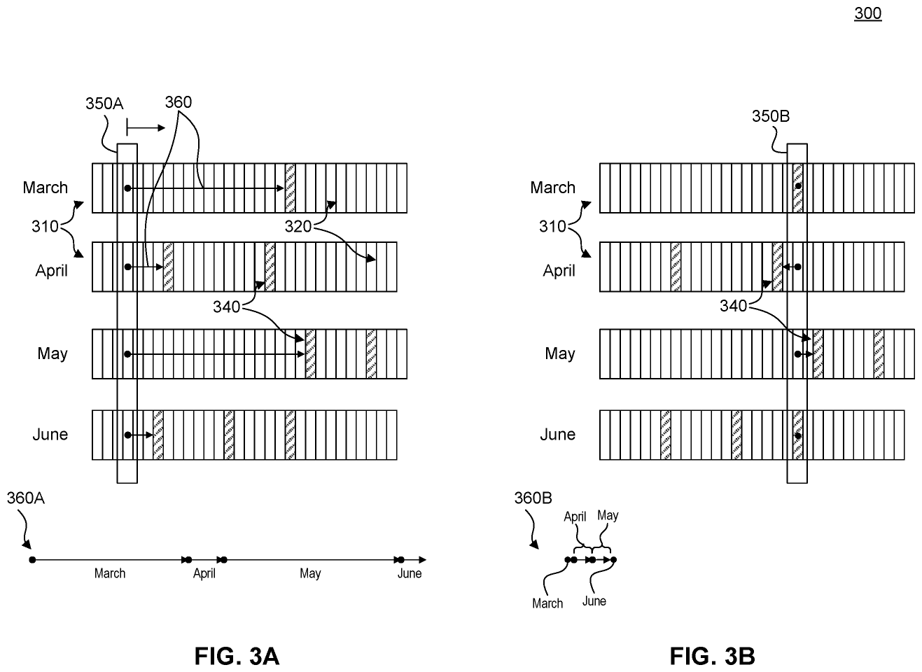

After the data parser 230 has extracted and organized the relevant data, the matrix constructor 240 organizes the extracted data into a matrix format. As discussed above, the matrix consists of a plurality of time periods of the transaction timeline arranged vertically. An example transaction matrix is illustrated in FIG. 3A, which is described in further detail below. In an embodiment, the matrix constructor 240 identifies the time periods, and the transactions pertaining to those transactions, based on date fields of the transaction data. Once the time periods have been identified, the matrix constructor organizes the various transaction entries into the different time periods, and constructs the matrix with time periods aligned vertically.

Once the matrix constructor 240 has generated the transaction matrix, the transaction matrix is provided to the recurrence analyzer 250. The recurrence analyzer 250 carries out one or more analysis subroutines of the transaction matrix in order to identify whether the customer has any recurring transactions with the merchant. The functionality of the recurrence analyzer 250 is discussed in further detail below, with respect to FIGS. 2B-5B. The recurrence analyzer 250 provides the results of the various analysis subroutines to the scoring engine 260.

The scoring engine 260 calculates recurrence score associated one or more series of transactions within the customer/merchant combination. The recurrence score indicates a likelihood that the series of transactions are recurring transactions. In an embodiment, the recurrence score is a number in the range of [0, 1], with a lower score indicating a lower likelihood of recurrence and a higher score indicating a higher likelihood of recurrence. Once the scoring engine 260 has calculated the recurrence score, the scoring engine 260 makes a determination as to whether the recurrence score is indicative of recurrence. In an embodiment, the determination is made based on a comparison of the recurrence score to a predetermined threshold.

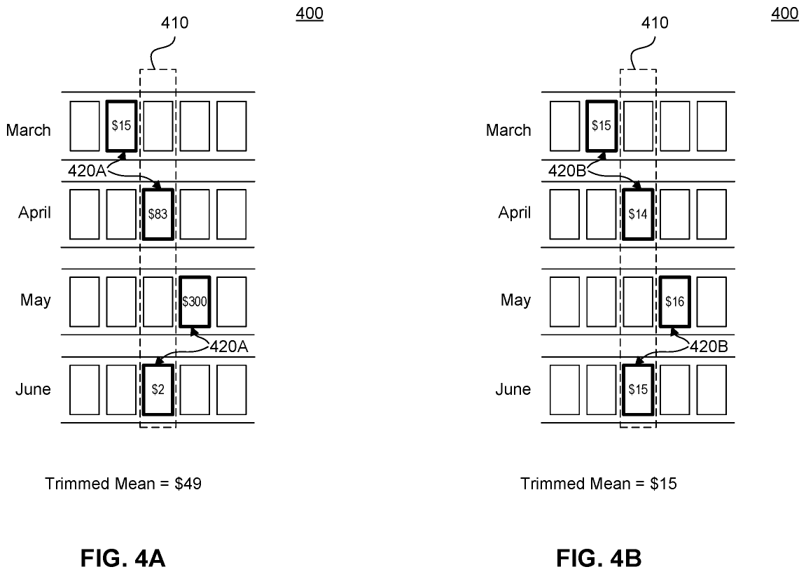

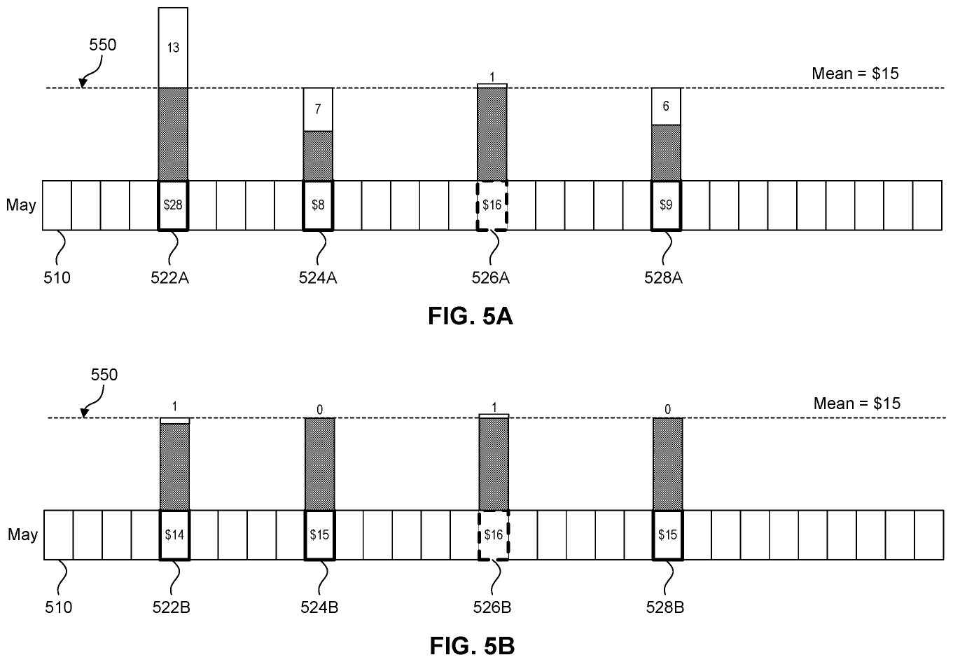

FIG. 2B illustrates a block diagram of an exemplary recurrence analyzer 250 used by the transaction analysis engine 220 of the transaction analysis system 200. In an embodiment, the recurrence analyzer 250 includes an alignment calculator 252, a value comparator 254, a noise detector 256, and a history counter 258. The alignment calculator 252 is described below with respect to FIGS. 3A and 3B, the value comparator 254 is described below with respect to FIGS. 4A and 4B, and noise detector 256 is described below with respect to FIGS. 5A and 5B. In various embodiments, the recurrence analyzer 250 may include more or fewer analysis subroutines.

### Alignment Calculator

FIG. 3A illustrates an exemplary transaction matrix 300 used by the recurrence analyzer 250. As shown, the time periods 310 (e.g., months) of the transaction timeline have been parsed apart from each other and vertically aligned. In other words, each time period forms a different row of the matrix and the time periods are arranged such that they are aligned by their time units 320. Thus, in the example of FIG. 3A, the first days of each month are vertically aligned in a first column, the second days of each month are vertically aligned in a second column, etc. For purposes of normalizing the lengths of the rows, each month may be configured with 31 time units. Naturally, a month that has been padded with extra days (e.g., February) will simply not have transaction entries on those days.

As can be seen in FIG. 3A, the transactions 340 are located within the transaction matrix in the row corresponding to the month in which they occurred, and at the column corresponding to the day on which they occurred.

Once the transaction matrix 300 has been constructed, the alignment calculator analyzes the matrix 300 to detect whether there are any transactions that are aligned between the time periods. In an embodiment, the alignment calculator performs this determination based on a columnal analysis. Specifically, the alignment calculator 252 begins with the first column of the transaction matrix 300 and performs a distance calculation for each of the rows. The distance calculation determines, for each row, the closest transaction to the currently-selected column. After performing this determination for the first column 320 of the transaction matrix, the determination is repeated for each subsequent column.

FIG. 3A illustrates a first example distance analysis. In this example, a first selected column 350A is analyzed. The analysis produces very large distances for the rows 1 and 3 (e.g., March and May), and medium distance for row 2 (e.g., April), and a short distance of row 4 (e.g., June). It should be noted that, although the illustrated distances are shown as being within a single month, in other examples the nearest transaction could be in another month, which would result in the distance traversing the boundary(ies) of the month. The alignment calculator 252 sums the distances of the rows in order to achieve a total distance 360A of the selected column 350A. This total distance 360A is temporarily stored in memory in association with the selected column 350A until all distance analyses have been performed.

After the alignment calculator finishes the analysis for the first selected column 350A, it performs the analysis for each subsequent column, storing each result in the memory. Like FIG. 3A, FIG. 3B illustrates the exemplary transaction matrix 300 used by the recurrence analyzer 250. The analysis of one such subsequent selected column 350B is illustrated in FIG. 3B.

As shown in FIG. 3B, rows 1 and 4 (e.g., March and June) of the transaction matrix include transactions that occurred on the day of the selected column 350B. This will result in a distance value of zero for those columns (represented in FIG. 3B by a dot). Meanwhile, rows 2 and 3 (e.g., April and May) have distances that are very small. Notably, in an embodiment, it is immaterial whether the nearest transaction is left of (e.g., earlier in time) or right of (e.g., later in time) the selected column 350B. Rather, an absolute value of the distance suffices. Therefore, the summation of the distances from the selected column 350B is illustrated as distance 360B. After completing this calculation, the alignment calculator 252 stores this distance in the memory in association with the selected column 350B. In another embodiment, rather than calculating and storing a total distance, the alignment calculator may instead calculate and store an average distance that is an average of the distances calculated for each row.

A column having a lower distance will indicate a higher likelihood of recurring transactions. This is because a shorter distance demonstrates a closer proximity of transactions to column, and thus a higher likelihood of recurrence. Conversely, a larger distance demonstrates a lower likelihood of recurrence. Therefore, in an embodiment, after the alignment calculator 252 has completed the distance analysis for each of the columns 320, the alignment calculator 252 identifies the column 320 with the smallest distance calculation. This column 320 is then used throughout subsequent subroutines. In another embodiment, the alignment calculator 252 identifies all columns 320 with distances that fall below a predetermined threshold. Subsequent subroutines are then performed for all identified columns 320. In yet another embodiment, all distances are maintained in memory until all subroutines have been performed. Thereafter, the scoring engine 260 calculates the scores for each column, using the calculated distances as one of many factors.

### Value Comparator

As shown in FIG. 2B, another subroutine that analyzes the transaction matrix is the value comparator 254. Whereas the alignment calculator 252 analyzes the proximity of transactions to a particular column of the matrix, the value comparator 254 examines the values of transactions nearest to the selected column. This is illustrated, for example, in FIGS. 4A and 4B. Recurring transactions tend to have the same or similar transaction amounts. The value comparator 254 analyzes the transactions nearest to a particular column of the matrix to determine the relative similarities of their transaction amounts.

FIG. 4A illustrates a portion of an exemplary transaction matrix 400A centered at a particular column of the transaction matrix undergoing examination. Once again, the value comparator 254 performs its analysis for each column of the transaction matrix 300. Thus, the value comparator 254 selects the first column of the transaction matrix 300, performs its analysis for that column, and stores the result of the analysis in memory. The value comparator 254 then selects the second column of the matrix 300 and repeats the process. This is repeated for each column of the transaction matrix until all columns have been analyzed.

FIG. 4A illustrates the analysis of a selected column 410 of the transaction matrix. As shown in FIG. 4A, first exemplary transactions 420A are illustrated in proximity to the selected column 410. In this first example, the transactions for rows 1-4 (e.g., March-June), respectively, are $15, $83, $300, and $2.

In an embodiment, the value comparator 254 first calculates a trimmed mean of the nearby transaction values. The trimmed mean is calculated by trimming (e.g., removing from the calculation) the top 25% of values and the bottom 25% of values from the nearby transaction values, and then calculating a mean of the remaining transactions. In the example of FIG. 4A, because there are four transactions, this would result in removing the top and bottom one transaction (e.g., May ($300) and June ($2)). The remaining transaction values (e.g., March ($15) and April ($83)) are then averaged. In the example of FIG. 4A, this results in a trimmed mean of $49.

After calculating the trimmed mean, the value comparator 254 compares each of the nearest transaction values of the transactions 420A. Based on the comparisons, the value comparator 254 calculates the relative similarity of each transaction value to the trimmed mean. In an embodiment, this similarity is calculated as a percentage difference. For example, the value comparator 254 subtracts the smaller of the transaction value and the trimmed mean from the larger, and then divides by the larger number. This produces a percentage deviation of the transaction value from the trimmed mean.

In the example of FIG. 4A, the value comparator 254 calculates the percentage deviation of March value as (49−15)/49=69% deviation. Similarly, the value comparator 254 calculates the percentage deviation of the April transaction as (83−49)/83=41% deviation. The value comparator 254 calculates the percentage deviations of May and June to be 84% and 96%, respectively, using the above formula.

FIG. 4B illustrates a portion of an exemplary transaction matrix 300 centered at the selected column 410. In this second example, the transaction values of the nearest transactions 420B are significantly closer to each other and to the trimmed mean. As described above, the value comparator trims the top and bottom 25% of values and then calculates a mean of the remaining values. In the example of FIG. 4B, this results in a trimmed mean of $15.

The value comparator 254 then compares each row's nearest transaction value to the trimmed mean, and calculates a percentage deviation. Using the same formula as described above with respect to FIG. 4A, the value comparator calculates the percentage deviations for the nearest transactions 420B of March-June as 0%, 7%, 6% and 0%, respectively.

In an embodiment, the value comparator 254 stores all the percentage deviations calculated for each row of the transaction matrix 300 in association with the columns for which they were calculated. In other words, the value comparator 254 stores the percentage deviations calculated for the first column, and also stores those calculated for the second column, etc. In another embodiment, the value comparator 254 averages the percentage deviations for a given column, and stores only the average. The value comparator 254 stores the average deviation for each column of the matrix.

In an embodiment, smaller percentage deviations or a smaller average percentage deviation for a given column evidences a higher likelihood of the transactions being recurring, and thus a higher likelihood that the given column includes a recurring transaction. This is because, as discussed above, recurring transactions are typically the same or very similar in value. Meanwhile, larger percentage deviations or a larger average percentage deviation for a given column evidences a lower likelihood of the transactions being recurring, and thus a lower likelihood that the given column includes a recurring transaction. In the examples of FIGS. 4A and 4B, the values of the transactions 420A produce an average deviation of 72.5% versus an average deviation of 3.25% for the transactions 420B. The scoring engine 260 calculates the recurrence score for each column (or for the column identified by the alignment calculator 252), using the percentage deviations as one of multiple factors. In the above examples, the values of FIG. 4B would score higher than those of FIG. 4A. Additionally, in an embodiment, a standard mean or median is calculated for use in the comparison rather than the trimmed mean described above.

### Noise Detection

As shown in FIG. 2B, another subroutine that analyzes the transaction matrix is the noise detection 256. Whereas the alignment calculator 252 and the value comparator 254 analyze columns of the matrix 300, the noise detection 256 analyzes the data within the rows of the matrix 300. Specifically, for a given column being analyzed, the noise detection 256 analyzes whether the transaction values within the row are more or less similar to the mean value of the selected column. In other words, for a given column being analyzed, the noise detection 256 determines the similarities of each of the transaction values in the row to the column mean. The noise detection 256 then compares the similarity of the nearest transaction to the column under test to those of the other transactions in the row. If the similarities are the same or nearly the same, then the transaction nearest the selected column could simply be the result of randomness (e.g., noise), and would thus weigh less toward recurrence. On the other hand, if the similarities of the other values are sufficiently different from that of the nearest transaction, then the nearest transaction value is less likely due to randomness, and thus more indicative of recurrence. Examples are illustrated, for example, in FIGS. 5A and 5B.

FIG. 5A illustrates an exemplary transaction timeline 500 associated with a particular transaction time period 510. As shown in FIG. 5A, the time period (e.g., May) consists of a plurality of time units (e.g., days). According to the transaction data, various transactions 522A-528A occurred on various days of the time period 510. Of those transactions, transaction 526A is considered to be nearest to the column under test.

To carry out this subroutine, the noise detection 256 first calculates the mean for the values in the selected column. In the example shown in FIG. 5A, the mean is $15. In an embodiment, the noise detection 256 instead calculates the trimmed mean or median of the transaction values in the same manner as discussed above.

After calculating the mean value for column under test, the noise detection 256 then compares the value of each transaction 522A-528A within the time period 510 to the calculated mean. This comparison is illustrated in FIG. 5A by the bar graph extending vertically from the time period 510. As shown, the value of transaction 522A ($28) differs from the calculated mean by $13. Likewise, the values of transactions 524A-528A differ by $7, $1 and $6, respectively. Because the nearest transaction (526A) is more similar to the mean value of the column under test than the other transactions in the row, the noise detection 256 identifies the nearest transaction as being more likely part of a recurrence.

FIG. 5B illustrates the exemplary transaction timeline 500 associated with the particular transaction time period 510. In this example, the values of the transactions 522B-528B differ from those of FIG. 5A, and are more similar to each other than those of FIG. 5A. As with the previous example, transaction 526B is determined to be the nearest transaction to the column under test. As with FIG. 5A, the noise detection 256 calculates the mean value of the column under test to $15.

The noise detection 256 then compares each of the transaction values to the mean value and determines a difference. This is illustrated in FIG. 5B by the bar graph extending vertically from the time period 510. As shown, the noise detection 256 determines that the value of transaction 522B differs from the mean value by $1. Likewise, the noise detection 256 determines that the values of transactions 524B-528B differ by $0, $1 and $0, respectively. Because the nearest transaction (526B) is not significantly more similar to the mean value of the column under test than the other transactions in the row, the noise detection 256 identifies the nearest transaction as being less likely part of a recurrence.

After calculating the difference values, the noise detection 256 stores the set of difference values in the memory. In an embodiment, the noise detection 256 calculates a mean of the difference values and stores the mean value. As with previous subroutines, the difference values and/or mean difference value is stored in association with identifying information of the transaction matrix 300 or the matrix row 510 to which the data pertains. In an embodiment, rather than calculated difference values, the noise detection 256 instead calculates and stores percentage deviations in substantially the same manner as discussed above with respect to value comparator 254.

### History Counter

As shown in FIG. 2B, the recurrence analyzer 250 also includes a history counter 258. The history counter 258 determines the length for which any apparent recurring transaction has been occurring. In an embodiment, the history counter makes this determination using a process similar to that of the alignment calculator 252.

Specifically, as discussed above, the alignment calculator determines the distance between a selected column and the nearest transaction in each of the rows of the transaction matrix 300. However, a recurring transaction may not be present throughout all of the time periods (e.g., rows) of the transaction matrix, and instead may have begun during the time duration in question. In other words, the recurring transaction may not be present during all time periods of the transaction matrix 300. In this scenario, some rows 310 of the transaction matrix 300 may have larger distances than others.

Therefore, the history counter 258 examines the distances calculated by the alignment calculator 252. The history counter 258 then determines, for each of the recorded nearest transactions, whether the nearest transaction is part of the recurring transaction or not based on its distance to the corresponding column. In an embodiment, the history counter 258 makes this determination by comparing the distance of each of the nearest transactions to a predetermined threshold value. Only the nearest transactions whose distances are determined to be less than the threshold are considered part of any potential recurring transaction. Other nearest transactions whose distances are above the threshold are determined to be excluded from the potential recurring transaction.

The results of the determination, including an identification of the number of nearest transactions that form a part of the potential recurring transaction, are recorded in memory. In an embodiment, the history counter 258 also records which specific ones of the nearest transactions were determined to form the potential recurring transaction. Here, a potential recurring transaction being formed by more transactions (e.g., with more transactions deemed sufficiently close) will be scored higher. In other words, more transactions will indicate a higher likelihood of the column representing a recurring transaction. A lower number of transactions will indicate a lower likelihood, and thus will be scored lower.

### Scoring Engine

After all the subroutines have completed, or on an ongoing basis as analysis results are received from each of the subroutines, scoring engine 260 calculates a recurrence score for the transaction timeline 100. In an embodiment, the scoring engine 260 receives the data from memory that was stored by each of the subroutines. The scoring engine 260 then sets a score for the transaction timeline 100 to be equal to 1 (100%). The scoring engine 260 then analyzes each of the data sets from the various subroutines in order to adjust the preset score.

For example, as discussed above, the scoring engine 260 adjusts the score down by a relatively large amount in response to detecting large proximity values (or a large average proximity value) from the alignment calculator 252. Conversely, the scoring engine 260 adjusts the score by a relatively small amount in response to detecting small proximity values (or a small average proximity value) from the alignment calculator 252.

Similarly, the scoring engine 260 adjusts the score down by a relatively large amount in response to detecting large percentage deviations (or a large average percentage deviation) from the value comparator 254. Conversely, the scoring engine 260 adjusts the score by a relatively small amount in response to detecting small percentage deviations (or a small average percentage deviation) from the value comparator 254.

Additionally, the scoring engine 260 adjusts the score down by a relatively large amount in response to detecting transactions closest to the column under test that are less similar to the column mean than other transactions in the row from the noise detection 256. Conversely, the scoring engine 260 adjusts the score down by a relatively small amount in response to detecting transactions closest to the column under test that are more similar to the column mean than other transactions in the row from the noise detection 256. The scoring engine 260 makes similar adjustments to the score based on the results of the other subroutines.

In other embodiments, scoring engine 260 begins with a preset score of 0.5 (e.g., 50%), and adjusts the score up or down based on the results of the various subroutines. In still another embodiment, scoring engine 260 begins with a preset score of 0, and makes positive adjustments. In other embodiments, regardless of the preset score employed by the scoring engine 260, the scoring engine 260 adjusts the score up and/or down based on the various subroutine results. In any such configuration, the scoring engine 260 does not produce a score greater than 1, or less than 0.

Once the scoring engine 260 has accounted for the results of all subroutines, the scoring engine 260 produces a final recurrence score. This score will be in the range of 0-1. The scoring engine 260 then makes a final determination as to whether a recurring transaction is present in the transaction timeline 100. In an embodiment, scoring engine 260 makes this determination by comparing the final recurrence score to a predetermined threshold. If the final recurrence score exceeds the threshold, then the scoring engine 260 determines that a recurring transaction is present in the data. Otherwise, the scoring engine 260 determines that no recurring transaction is present.

Exemplary Method of Recurrence Detection

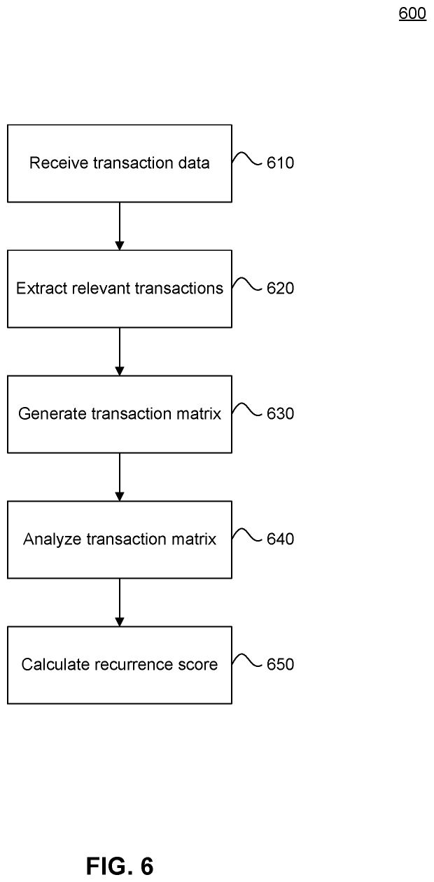

FIG. 6 illustrates a block diagram of an exemplary method 600 for detecting a recurring transaction, which may be carried out by the analysis engine 220 described above with respect to FIG. 2A. For reference purposes, the method 600 will be described with respect to FIG. 2A.

As shown in FIG. 6, the method 600 begins at step 610 wherein the data parser 230 receives transaction data 610. In an embodiment this transaction data may include transaction data for multiple users and/or merchants. Therefore, after receiving the transaction data, the data parser extracts relevant transactions (620). The relevant transactions are those between a particular user and a particular merchant.

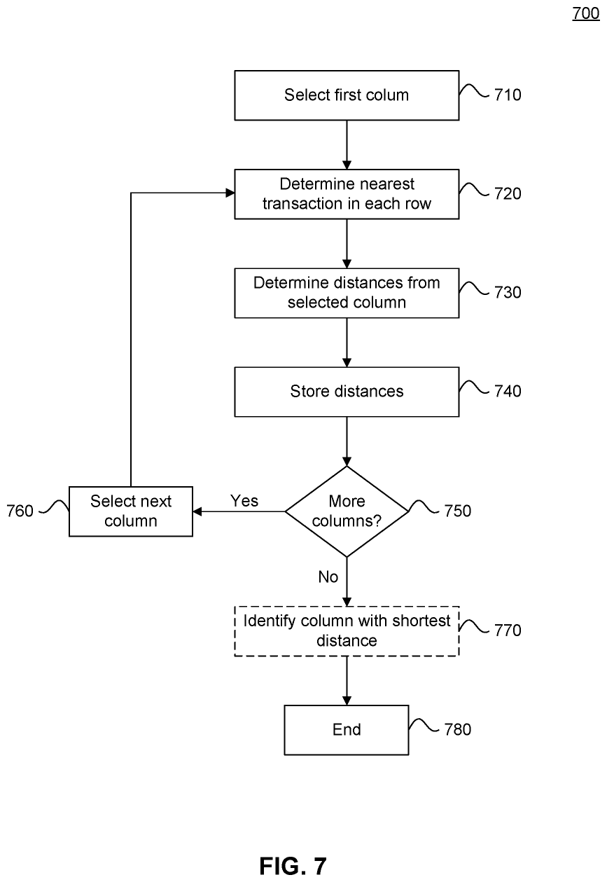

Once the relevant transactions have been extracted, a matrix constructor 240 organizes the relevant transactions into a transaction matrix (630). As discussed above, the matrix is composed of a plurality of time periods forming the rows of the transaction matrix. Each time period consists of a plurality of time units, and the time periods are aligned by the time units. Thereafter, the recurrence analyzer 250 analyzes the transaction matrix (640). This analysis is described in further detail with respect to FIGS. 7-9, below.

Lastly, scoring engine 260 calculates a recurrence score (650) based on the results of the analysis from step 640. In an embodiment, the recurrence score is a number between 0-1 indicative of the relative likelihood that the extracted transactions include a recurring transaction.

Many modifications to the method 600 may be available. For example, rather than receiving transaction data that includes irrelevant transactions, only relevant transactions may be requested and received from a transaction database. Other modifications may also be available.

FIG. 7 illustrates a block diagram of an exemplary method 700 for carrying out an alignment subroutine of the alignment calculator 252. As shown in FIG. 7, the method begins by selecting a first column (710) of the transaction matrix for analysis. Next, for the selected column, a nearest transaction to the selected column is identified in each row (720).

Once the nearest transactions have been identified, a distance is calculated between each of the nearest transactions and the selected column (730). In an embodiment, this distance is calculated as the number of time units separating the selected column and the time unit of the nearest transaction. These distances are then stored in memory for later use (740).

This process is then repeated for a plurality of other columns in the transaction matrix. In an embodiment, this process is repeated for all other columns. In either case, a determination is made as to whether there are more columns that require analysis (750). If there are (750—Y), then a next column is selected (760) and the analysis (720-750) is repeated for the newly-selected column. In an embodiment, once all columns have been analyzed (750—N), the stored distances of the various columns are compared in order to identify a column with the shortest distance (770). Thereafter, the method ends (780).

Many modifications to the method 700 may be available. For example, rather than storing multiple distances for each column, the distances may be stored as an average distance. The comparison in step 770 is then performed between the stored average distances. Other modifications may also be available.

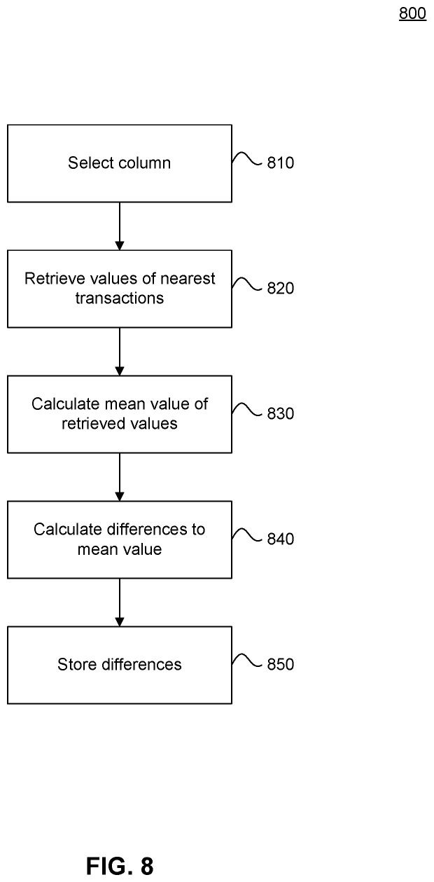

FIG. 8 illustrates a block diagram of an exemplary method 800 for carrying out a value comparison subroutine. In an embodiment, the value comparator 254 carries out this method. As shown in FIG. 8, the method 800 begins at step 810, where a column is selected. In an embodiment, the selected column is the same as the column previously identified in FIG. 7 as having the smallest distance.

Once selected, the transaction values of each nearest transaction (the transaction in each row closest to the selected column) are retrieved (820). In an embodiment, the nearest transactions are identified from the stored transactions from the alignment subroutine illustrated in FIG. 7. Thereafter, a mean value of the retrieved transaction values is calculated (830).

After the mean has been calculated, each of the transaction values is individually compared to the mean value and the difference between those transaction values and the mean value is calculated (840). These differences are then stored in memory for later use (850).

Many modifications to the method 800 may be available. For example, rather than storing multiple differences for each nearest value, the differences may be stored as an average difference. Additionally, the mean value in step 830 may be calculated either as a mean or a trimmed mean of the nearest transaction values. Also, the subroutine of FIG. 8 could be run for each of the other columns, so that each column has a chance to be the “column under test.” Other modifications may also be available.

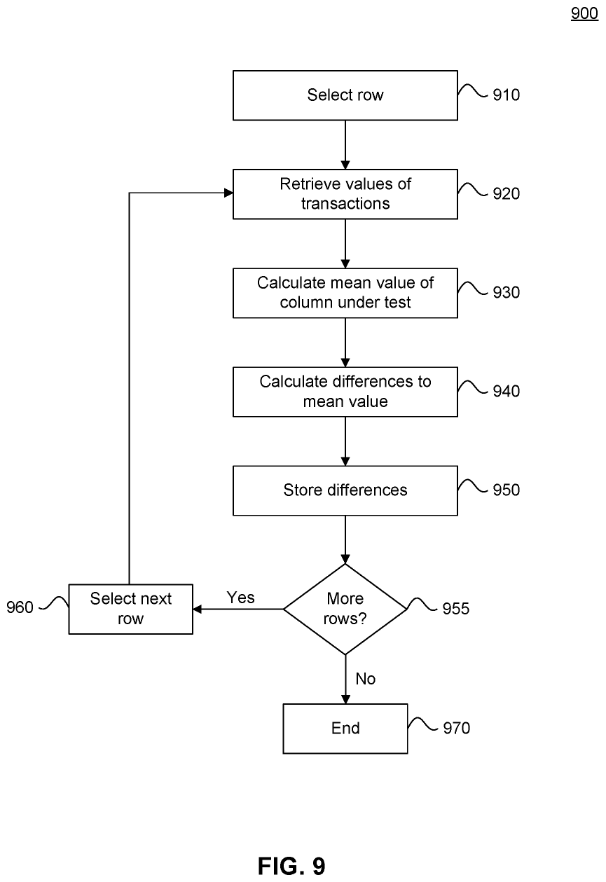

FIG. 9 illustrates a block diagram of an exemplary method 900 for carrying out a noise detection subroutine. In an embodiment, the noise detection subroutine of FIG. 9 is carried out by noise detection 256.

As illustrated in FIG. 9, the method 900 begins with step 910 in which a row of the transaction matrix is selected. For the selected row, the values of all transactions in the row are retrieved (920). Then, a mean value of the transaction values in a column under test is calculated (930).

After the mean value has been calculated, each of the transaction values is individually compared to the mean value and the difference between those transaction values and the mean value is calculated (840). These differences are then stored in memory for later use (950).

This process is then repeated for each other row of interest. In other words, a determination is made as to whether there are more rows for which analysis is required (955). If there are (955—Y), then the next row is selected (960) and steps 920-950 are repeated for the newly-selected row. Once all rows have been analyzed (955—N), the process ends (970).

Many modifications to the method 900 may be available. For example, rather than storing a difference for each transaction value, the differences may be stored as an average difference. Additionally, the mean value in step 930 may be calculated either as a mean or a trimmed mean of the transaction values. Also, the subroutine illustrated in FIG. 9 could be performed for each column, so that each column has a chance to the be the “column under test.” Other modifications may also be available.

Together, these various subroutines can be combined to perform comprehensive and accurate recurrence detection, which can have a variety of useful applications. In one example, when recurring transactions are detected, changes to the recurring transactions can also be detected, which can be particularly useful for preventing fraud and/or unexpected charges. For example, when a change to a recurring transaction is detected, the system can automatically generate a notification to the account owner to confirm the change: E.g., “Your monthly payment went up by 5 dollars. Was this expected?” In another example, known recurring transactions can be stored in a database and commuted to a new account or transferred to a new bank, either in response to a user request or in response to detecting fraud in other areas of the account.

In yet another example, the detection of a recurring transaction can be used to initiate setup of a virtual number to replace other account information on file with a merchant (e.g., the recurrence of a transaction may be an indicator of a “card on file” with that merchant). Specifically, a virtual number functions like a credit card number or an account, but is virtual (e.g., not itself an account). The number may only appear at checkout and provides a unique virtual card/account number only for that particular retailer/website. This provides a benefit if the virtual number is compromised: it can be merely terminated or deactivated without requiring closure of the underlying account. There are also useful applications outside of banking.

Exemplary Computer System Implementation

It will be apparent to persons skilled in the relevant art(s) that various elements and features of the present disclosure, as described herein, can be implemented in hardware using analog and/or digital circuits, in software, through the execution of instructions by one or more general purpose or special-purpose processors, or as a combination of hardware and software.

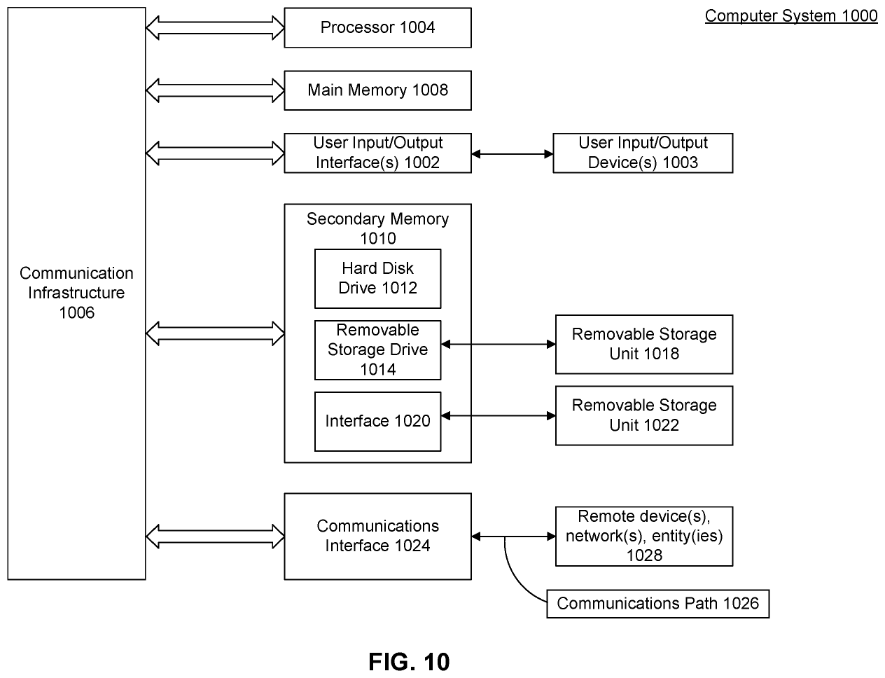

The following description of a general purpose computer system is provided for the sake of completeness. Embodiments of the present disclosure can be implemented in hardware, or as a combination of software and hardware. Consequently, embodiments of the disclosure may be implemented in the environment of a computer system or other processing system. An example of such a computer system 1000 is shown in FIG. 10. One or more of the elements depicted in the previous figures can be at least partially implemented on one or more distinct computer systems 1000, such as the transaction analysis engine 220 or any of the elements therein, as well as the recurrence analyzer or any of the elements therein.

Computer system 1000 includes one or more processors, such as processor 1004. Processor 1004 can be a special purpose or a general purpose digital signal processor. Processor 1004 is connected to a communication infrastructure 1002 (for example, a bus or network). Various software implementations are described in terms of this exemplary computer system. After reading this description, it will become apparent to a person skilled in the relevant art(s) how to implement the disclosure using other computer systems and/or computer architectures.

Computer system 1000 also includes a main memory 1006, preferably random access memory (RAM), and may also include a secondary memory 1008. Secondary memory 1008 may include, for example, a hard disk drive 1010 and/or a removable storage drive 1012, representing a floppy disk drive, a magnetic tape drive, an optical disk drive, or the like. Removable storage drive 1012 reads from and/or writes to a removable storage unit 1016 in a well-known manner. Removable storage unit 1016 represents a floppy disk, magnetic tape, optical disk, or the like, which is read by and written to by removable storage drive 1012. As will be appreciated by persons skilled in the relevant art(s), removable storage unit 1016 includes a computer usable storage medium having stored therein computer software and/or data.

In alternative implementations, secondary memory 1008 may include other similar means for allowing computer programs or other instructions to be loaded into computer system 1000. Such means may include, for example, a removable storage unit 1018 and an interface 1014. Examples of such means may include a program cartridge and cartridge interface (such as that found in video game devices), a removable memory chip (such as an EPROM, or PROM) and associated socket, a thumb drive and USB port, and other removable storage units 1018 and interfaces 1014 which allow software and data to be transferred from removable storage unit 1018 to computer system 1000.

Computer system 1000 may also include a communications interface 1020. Communications interface 1020 allows software and data to be transferred between computer system 1000 and external devices. Examples of communications interface 1020 may include a modem, a network interface (such as an Ethernet card), a communications port, a PCMCIA slot and card, etc. Software and data transferred via communications interface 1020 are in the form of signals which may be electronic, electromagnetic, optical, or other signals capable of being received by communications interface 1020. These signals are provided to communications interface 1020 via a communications path 1022. Communications path 1022 carries signals and may be implemented using wire or cable, fiber optics, a phone line, a cellular phone link, an RF link and other communications channels.

As used herein, the terms “computer program medium” and “computer readable medium” are used to generally refer to tangible storage media such as removable storage units 1016 and 1018 or a hard disk installed in hard disk drive 1010. These computer program products are means for providing software to computer system 1000.

Computer programs (also called computer control logic) are stored in main memory 1006 and/or secondary memory 1008. Computer programs may also be received via communications interface 1020. Such computer programs, when executed, enable the computer system 1000 to implement the present disclosure as discussed herein. In particular, the computer programs, when executed, enable processor 1004 to implement the processes of the present disclosure, such as any of the methods described herein. Accordingly, such computer programs represent controllers of the computer system 1000. Where the disclosure is implemented using software, the software may be stored in a computer program product and loaded into computer system 1000 using removable storage drive 1012, interface 1014, or communications interface 1020.

In another embodiment, features of the disclosure are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### CONCLUSION

It is to be appreciated that the Detailed Description section, and not the Abstract section, is intended to be used to interpret the claims. The Abstract section may set forth one or more, but not all exemplary embodiments, and thus, is not intended to limit the disclosure and the appended claims in any way.

Embodiments of the invention have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

It will be apparent to those skilled in the relevant art(s) that various changes in form and detail can be made therein without departing from the spirit and scope of the disclosure. Thus, the invention should not be limited by any of the above-described exemplary embodiments, but should be defined only in accordance with the following claims and their equivalents.

What is claimed is:

1. A recurrence detection system for detecting a recurring transaction in a history of transactions, the system comprising:
a database that stores the history of transactions; and
an analysis engine including:
a data parser configured to receive the history of transactions from the database and to extract transactions that occurred between an individual and a merchant during a duration of time;
a matrix constructor configured to organize the extracted transactions into a matrix;
a recurrence analyzer configured to analyze the matrix and store data indicative of a presence or absence of a recurring transaction; and
a scoring engine configured to determine whether a recurring charge exists in the extracted transactions based on the stored data.

2. The recurrence detection system of claim 1, wherein the matrix constructor generates the matrix by dividing the duration of time into time periods and organizing the time periods into rows of the matrix.

3. The recurrence detection system of claim 2, wherein the time periods each have a plurality of time units, and
wherein the matrix constructor inserts each extracted transaction at the time unit on which it occurred.

4. The recurrence detection system of claim 1, wherein the recurrence analyzer includes an alignment calculator, a value comparator, noise detection, and a history counter, each configured to execute a subroutine for analyzing the matrix.

5. The recurrence detection system of claim 4, wherein the alignment calculator is configured to calculate, for each column of the matrix, a distance from the column to each nearest transaction in each row of the matrix.

6. The recurrence detection system of claim 4, wherein the value comparator is configured to identify, for each column of the matrix, a nearest transaction in each row of the matrix and to determine a relative similarity between transaction values of the identified nearest transactions.

7. The recurrence detection system of claim 4, wherein the noise detection is configured to calculate a relative similarity of each transaction value within a row of the matrix to a mean value of transactions within a selected column.

8. A recurring event analysis device for analyzing events arranged in a matrix, the matrix being configured with each row corresponding to a time period and each time period consisting of a plurality of time units, the recurring event analysis device comprising:
one or more circuits or processors configured to:
perform a first analysis on each of a plurality of columns of the matrix;
select one of the plurality of columns based on the results of the first analysis;
perform a second analysis on the selected column; and
perform a row analysis on a plurality of rows of the matrix.

9. The recurring event analysis device of claim 8, wherein the first analysis includes calculating for each of the plurality of columns an average relative distance between the column and nearest event in each row of the matrix.

10. The recurring event analysis device of claim 9, wherein the selecting selects the column with the smallest average relative distance.

11. The recurring event analysis device of claim 9, wherein the second analysis includes calculating for the selected column a relative similarity between values of the nearest events.

12. The recurring event analysis device of claim 8, wherein the row analysis includes calculating a relative similarity between each value of events within a row of the matrix to a mean value of transactions within a selected column.

13. The recurring transaction analysis device of claim 9, wherein the one or more circuits or processors are further configured to determine a number of qualifying events with respect to the selected column based on a distance between the column and each nearest event.

14. A method for identifying a recurring transaction in a set of transaction data, the method comprising:
receiving a history of transactions;
extracting transactions from the history that occurred between a user and a merchant;
generating a transaction matrix that includes the extracted transactions located at positions in the transaction matrix corresponding to a date on which they occurred;
analyzing the matrix; and
generating a recurrence score based on the analyzing indicative of a relative likelihood that a recurring transaction between the user and the merchant exists.

15. The method of claim 14, wherein the generating of the transaction matrix includes dividing a duration of time into time periods and organizing the time periods into rows of the transaction matrix, each row being aligned by respective time units of the time periods.

16. The method of claim 15, wherein the analyzing includes calculating for each of a plurality of columns of the transaction matrix an average relative distance between the column and nearest transactions in each row of the transaction matrix.

17. The method of claim 16, wherein the analyzing includes calculating for at least one column of the transaction matrix a relative similarity between transaction values of the nearest transactions.

18. The method of claim 16, wherein the analyzing includes selecting a column from among the plurality of columns based on the calculating of the average distance, and
wherein the at least one column is the selected column.

19. The method of claim 15, wherein the analyzing includes calculating a relative similarity between each transaction value of transactions in a row of the matrix to a mean value of transactions within a selected column.

20. The method of claim 15, wherein the generating of the recurrence score includes presetting the recurrence score to a predetermined value and increasing or decreasing the recurrence score based on results of the analyzing.
